(19) United States
(12) Patent Application Publication
(10) Pub. No.: US 2017/0348604 A1
(43) Pub. Date: Dec. 7, 2017

(54) MAGNETIC BUILDING BLOCKS AND METHODS OF MANUFACTURING THEREOF

(71) Applicant: HADALI TOYS, LLC, Salem, CT (US)

(72) Inventor: Igor Steven GARCIA, Salem, CT (US)

(73) Assignee: HADALI TOYS, LLC, Salem, CT (US)

(21) Appl. No.: 15/612,867

(22) Filed: Jun. 2, 2017

Related U.S. Application Data
(60) Provisional application No. 62/344,873, filed on Jun. 2, 2016.
(60) Provisional application No. 62/472,464, filed on Mar. 16, 2017.

(51) Int. Cl. A63H 33/04; B29C 64/106; B33Y 80/00; B29C 45/14; A63H 33/26; B29L 31/52; B29K 105/20

(52) U.S. Cl. CPC A63H 33/046; B29C 45/14819; B29C 64/106; A63H 33/26; B33Y 80/00; B29K 2105/20; B29K 2995/0008; B29L 2031/5209

(57) ABSTRACT

An interlocking toy building block includes a first block body and a first magnet positioned therein a first distance from a first outer surface thereof to provide a first predetermined magnetic polarity to the first outer surface. When the first outer surface is brought into close proximity with a second outer surface of a second block body having a second magnet positioned a second distance therein and exhibiting a second predetermined magnetic polarity opposing the first predetermined magnetic polarity, the first outer surface is configured to mate with the second outer surface in an interlocking position. A potential magnetic force Fₘ between the pair of magnets is determined by the formulation: Fₘ=Fₒ e^{-rd} where Fₒ is the initial force (i.e., no separation distance between magnets), and e^{-rd} is the exponential function of the rate of decay “r” of the magnets and the distance “d” between the magnets.

### CROSS-REFERENCE TO RELATED APPLICATIONS

The present application claims the benefit under 35 U.S.C. §119(e) of Provisional Patent Application Ser. No. 62/344,873, filed Jun. 2, 2016, and further claims the benefit under 35 U.S.C. §119(e) of Provisional Patent Application Ser. No. 62/472,464, filed Mar. 16, 2017, the disclosures of all of which are incorporated by reference in their entirety.

### BACKGROUND

### 1. Field of the Invention

The present invention is directed to interlocking toy building blocks having magnets embedded therein and to methods for manufacturing such interlocking toy building blocks.

### 2. Description of Related Art

Toy blocks or bricks are typically fabricated from wood, plastic, or foam pieces, and form various shapes that are used as building blocks. Playing with the toy blocks builds strength in a child's fingers and hands, improves eye-hand coordination, and teaches children about different shapes. Playing with the toy blocks also encourages interaction creativity and imagination, and provides for social play.

The toy building blocks typically are fabricated from wood or plastic. Wooden toy blocks are susceptible to hosting germs and bacteria as a result of their organic composition. In contrast, polymeric blocks are easier to clean; thus, preventing the transfer of germs and bacteria, particularly if blocks are used in schools, or hospitals where there is a large communal gathering. The toy building blocks also typically are made available in a variety of colors or are marked with numbers or letters painted or imprinted thereon. Painted wooden blocks typically fade or otherwise lose their color or mark. Some paint, when consumed, can be hazardous particularly if a high Volatile Organic Compound (“VOC”) is present. Unlike wooden blocks, building blocks manufactured from polymers are not require to be painted. Plastic or polymeric building blocks can have their colors embedded in the pellets thus making it part of the composition.

Interlocking toy building blocks and bricks provide for the attachment or mating of toy block faces having a mechanical interlocking feature. For example, some building blocks have a top face that includes a protrusion extending outwardly therefrom that is received within a corresponding cavity extending inwardly into a bottom face of another building block. However, such mechanically interlocking building blocks require the precise positioning of the protrusions of one building block with the corresponding cavity of another building block, and human force to mate the blocks, which can be problematic for individuals of all ages who lack the strength and/or coordination to mate the blocks.

Some toy building blocks employ magnets to bring together the blocks to build upon an assembly of the blocks. However, the magnetic toy building blocks currently in the marketplace employ exposed magnets which are hazardous to kids if ingested. For example, wooden toy blocks typically employ wood glue to attach wooden subcomponents encasing a magnet. Wood glue can become loosened if exposed to relative elevated temperatures which can loosen the glue, thus loosening up the mating faces and revealing the magnets therein which creates a hazard for children. Moreover, fabricating wooden blocks having magnets disposed thereon is labor intensive and comparatively of high cost in relation to fabricating plastic or polymeric blocks having magnets disposed therein such as by, for example, injection molding.

Injection molding is a common manufacturing method for plastic toys including toy building blocks. A plastic or polymer material is injected under pressure into a two-part mold. The material is allowed to cool, the mold is opened, and the solid building blocks inside the mold are ejected from the mold. However, there are many known problems associated with injection molding. Poorly designed, poorly made, or deteriorating molds produce defects in the final product. A mold fabricated from a relatively low-cost material will wear rapidly; but higher quality molds fabricated from steel or stainless steel require a relatively high capital expenditure for fabricating toy blocks. The injection molding process often yields defective products such as, for example, an inadequate amount of plastic or polymer that does not fully fill out the mold during injection will result in an incomplete part. Other known problems resulting in defective product include not properly heating the plastic or inadequately pressurizing the mold such that the plastic does not fill out the mold.

Additional problems must be overcome when using an injection molding process to form toy building blocks having magnets disposed therein. The positioning of magnets in a mold is a complicated and costly process. The mold components must be fabricated to include place-holders or mounts for the magnets. Thus, separate molds must be fabricated for each alternative magnet positioning within a building block. In addition, the injection of the plastic or polymer into the mold and the subsequent application of pressure often dislodges the magnets placed within the mold such that the magnets are particularly positioned within the finished product. It is further known that injection-molded building blocks exhibit a seam which is known to deteriorate over time thus revealing the magnets therein which creates a hazard for children.

Additive Manufacturing, commonly known as 3-D Printing, is another common manufacturing method for plastic toys including toy building blocks. Additive manufacturing is a process in which layers of material are formed under computer control to produce a finished three-dimensional object. Objects can be of almost any shape or geometry and are produced using a digital design such as, for example, digital model data from an actual prototype or an electronic data source such as an additive manufacturing file (“AMF”) or computer-aided design (“CAD”) model. However, like injection molding, there are many known problems associated with additive manufacturing, and in particular, with additive manufacturing of toy building blocks having magnets embedded therein. Such building blocks produced by additive manufacturing are fragile and become delaminated thus revealing the magnets therein which creates a hazard for children. Moreover, the complexity of the additive manufacturing process itself is often daunting and involves substantial adjusting of processing formats, parameters, and mechanical features Like injection molding, the additive manufacturing process itself often displaces the magnets to be particularly positioned within the finished product.

What is needed is a toy interlocking building block that is relatively inexpensive to manufacture, thus making the final product relatively inexpensive at retail, and does not employ coatings of paint and glue. What is further needed is a toy interlocking building block that requires minimal effort to align and mate with another block. What is also needed is a manufacturing process for fabricating the interlocking toy building blocks that employs magnets to bring together the blocks to build upon an assembly of the blocks; wherein such a manufacturing process encapsulates or otherwise traps the magnets into a fixed position thereby preventing the exposure or loss of a magnet and creating a hazard for children. What is also needed is a manufacturing process for toy building blocks that produces seamless building blocks having the magnets properly positioned therein.

### SUMMARY OF THE INVENTION

One embodiment of the present invention is directed to an interlocking toy building block, the block comprising: a first block body; and at least one first magnet positioned inwardly into the first block body a first predetermined distance from a first outer surface of the first block body to provide a first predetermined magnetic polarity, positive or negative, to the first outer surface; wherein, when the first outer surface is brought into close proximity with a second outer surface of a second block body having at least one second magnet positioned a second predetermined distance therein and exhibiting a second predetermined magnetic polarity opposing the first predetermined magnetic polarity, the first outer surface configured to mate with the second outer surface in an interlocking position.

In one embodiment of the present invention, the first and second predetermined distances are in the range of from about 1 mm to about 5 mm. In one embodiment of the present invention, the first and second predetermined distances predetermined distances are equal. In one embodiment of the present invention, the first and second predetermined distances predetermined distances are in the range of about 2 mm.

In one embodiment of the present invention, the block further comprises at least a first pair of magnets defined by the at least one first magnet and the at least one second magnet; and a potential magnetic force Fₘ between the at least one first magnet and the at least one second magnet determined by the formulation: Fₘ=Fₒ e^{-rd} where Fₒ is the initial force (i.e., no separation distance between magnets), and e^{-rd} is the exponential function of the rate of magnetic field decay “r” of a substrate of the magnets and the distance “d” between the magnets.

In one embodiment of the present invention, the first block body is fabricated from a material having a density in the range of about 1×10⁻⁶ kg/mm³ to about 1.25×10⁻⁶ kg/mm³. In one embodiment of the present invention, the first block body is fabricated from a material having a density in the range of about 1×10⁻⁶ kg/mm³ to about 1.25×10⁻⁶ kg/mm³.

### BRIEF DESCRIPTION OF THE DRAWINGS

FIG. 1 is an isometric view of a magnetic building block in accordance with one embodiment of the present invention.

FIG. 2 is side elevation view of the magnetic building block of FIG. 1.

FIG. 3 is a front elevation view of the magnetic building block of FIG. 1.

FIG. 4 is an isometric view of a plurality of the magnetic building blocks of FIG. 1 showing the magnetic properties thereof.

FIG. 5 is side elevation view of another configuration of a magnetic building block in accordance with one embodiment of the present invention.

FIG. 6 is side elevation view of another configuration of magnetic building block in accordance with one embodiment of the present invention.

FIG. 7 is an isometric view of another configuration of a magnetic building block in accordance with one embodiment of the present invention.

### DETAILED DESCRIPTION

The present invention provides interlocking toy building blocks having magnets embedded therein and methods for manufacturing such interlocking toy building blocks. The toy interlocking building blocks of the present invention are relatively inexpensive to manufacture such that the final product is correspondingly relatively inexpensive at retail. The toy interlocking building blocks of the present invention do not employ coatings of paint and glue, and require minimal effort to align and mate with another block. The present invention further provides methods of manufacturing for fabricating the interlocking toy building blocks that encapsulate or otherwise trap the magnets into a fixed position thereby preventing the exposure or loss of a magnet and creating a hazard for children. The methods of manufacturing of the present invention produce seamless building blocks having the magnets properly positioned therein.

One embodiment of a method of manufacturing of the present invention employs embedded magnets within a whole injection molded building block wherein the injection molded process traps the magnets in a predetermined position as the molten plastic fills the mold and encapsulates the magnets disposed therein. Another embodiment of a method of manufacturing of the present invention employs a whole additive manufacturing wherein the additive manufacturing process traps and encases the embedded magnets in a predetermined position within the molten plastic inside a sealed surface. In both such processes, the blocks are manufactured from polymers that are not required to be painted because various colors embedded in the raw plastic material, such as for example, plastic pellets or powder, thus making color a feature of the composition of the building block. In addition, both such processes can advantageously use raw plastic material manufactured from recyclable materials or organic polymers, known as bioplastics, produced from renewable sources such as barley, wheat, and other renewable materials.

One embodiment of the interlocking toy building blocks of the present invention includes magnets embedded therein wherein magnetism provides the physical property for interlocking the building blocks. The present invention employs the physical properties of magnetism to create locking features, as in the case of two magnets attracting each other, or the case of a magnet being attracted to a metallic surface such as iron, cobalt, nickel or an alloy derivation of such metallic elements. This feature enables people of all ages who do not possess the strength and/or coordination to mate mechanical interlocking building blocks to use the interlocking toy building blocks of the present invention. In addition, users learn of, and are encouraged to explore, related aspects of science such as magnetism, magnetic fields, permeability, porosity, and the like. The magnetic whole polymeric building blocks of the present invention are easy to clean and do not employ coatings of potentially hazardous paint.

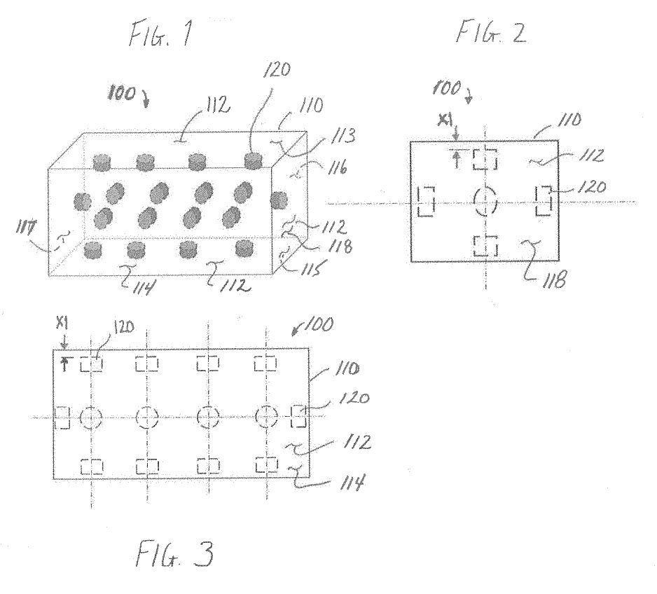

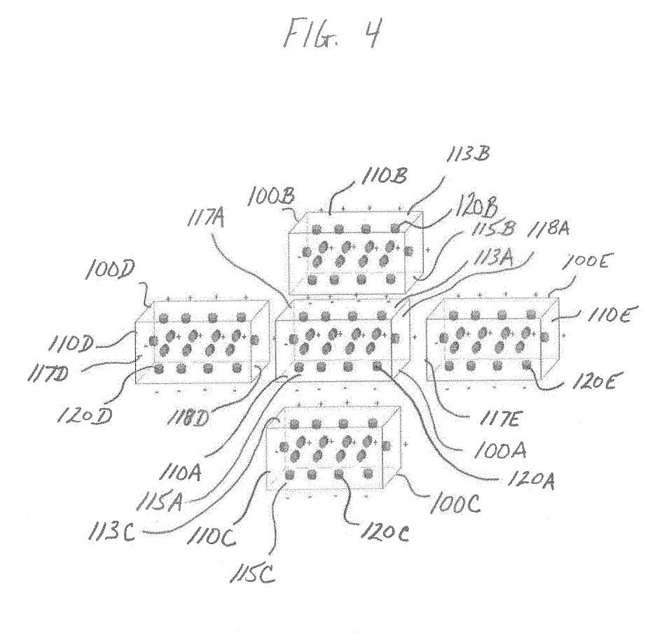

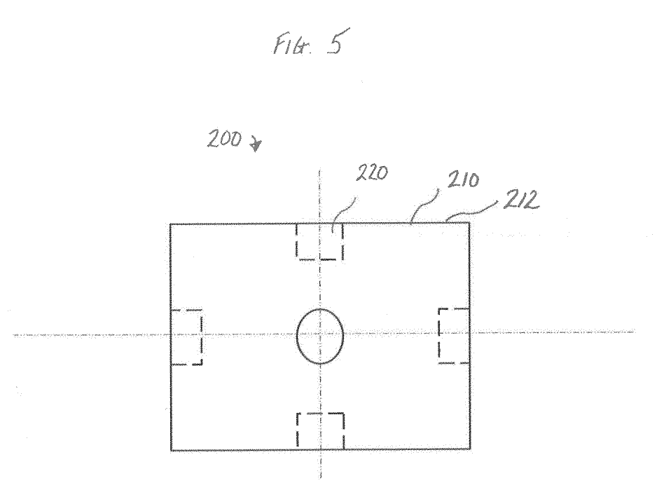

An interlocking toy building block 100 of the present invention is shown in FIGS. 1, 2 and 3, and is referred to hereinafter as “block 100.” The block 100 includes a block body 110 having an outer surface 112 on each side of the block body 110. One or more magnets 120 are positioned within the block body 110 below each outer surface 112 such that the magnets 120 lie embedded inside the block 100. Each magnet 120 is positioned a predetermined distance X1 inwardly into block body 110 from a respective outer surface 112 to ensure magnetism radiates and provides for interlocking one block 100 with other blocks 100. The outer surface 112 of the block body 110 includes a top surface 113, a front surface 114, a bottom surface 115, a back surface 116, a left-side surface 117 and a right-side surface 118.

A plurality of the magnetic building blocks of the present invention are shown in FIG. 4 with an indication of the magnetic properties thereof, namely, blocks 100A, 100B, 100C, 100D and 100E. Magnetic poles of opposite polarity attract each other, and such polarity is indicated as positive “+” and negative “−”. As negative charged surface areas of a geometrical shape, meet positively charged surface areas of other geometrical shapes, a magnetic attraction between the mating faces occurs and causes the geometrical shape to lock into a position abutting each other. Each of the blocks 100 respectively includes magnets 120 that are strategically positioned within the block body 110 to provide a predetermined type of polarity, positive or negative, thereby providing positively and negatively charged mating outer surfaces 112. When different blocks 100 having magnets 120 embedded therein such that opposing positively and negatively charged mating outer surfaces 112 of respective blocks 100 are brought into close proximity, the opposite magnetic charge leads to a magnetic attraction between the blocks 100 which mates the outer surfaces 112 into an interlocking position.

For example, block 100A includes magnets 120A embedded within a top surface 113A and a bottom surface 115A wherein the respective embedded magnets 120A define a negative polarity facing outwardly. Block 100B includes magnets 120B embedded within a top surface 113B and a bottom surface 115B wherein the respective embedded magnets 120B define a positive polarity facing outwardly. Thus, the top surface 113A of block 100A is magnetically attracted to the bottom surface 115B of block 100B and the blocks 100A and 100B are magnetically interlocked. Similarly, block 100C includes magnets 120C embedded within a top surface 113C wherein the embedded magnets 120C define a positive polarity facing outwardly. Thus, the top surface 113C of block 100C is magnetically attracted to the bottom surface 115A of block 100A and the blocks 100A and 100C are magnetically interlocked. In contrast to blocks 100A and 100B, the magnets 120C embedded within a bottom surface 115C of block 100C define a reverse polarity facing outwardly relative to the top surface 113C, namely, the embedded magnets 120C define a negative polarity facing outwardly from bottom surface 115C. Thus, various blocks 100 are employed to build upon each other in a variety of mating positions.

The magnets 120 embedded within the left-side surface 117 and the right-side surface 118 of each block 100 similarly define predetermined polarities facing outwardly. For example, block 100A includes magnets 120A embedded within a left-side surface 117A wherein the respective embedded magnets 120A define a negative polarity facing outwardly. Block 100D includes magnets 120D embedded in a right-side surface 118D wherein the respective embedded magnets 120D define a positive polarity facing outwardly. Thus, the left-side surface 117A of block 100A is magnetically attracted to the right-side surface 118D of block 100D and the blocks 100A and 100D are magnetically interlocked. Similarly, block 100A includes magnets 120A embedded within a right-side surface 118A wherein the respective embedded magnets 120A define a positive polarity facing outwardly. Block 100E includes magnets 120E embedded in a left-side surface 117E wherein the respective embedded magnets 120E define a negative polarity facing outwardly. Thus, the right-side surface 118A of block 100A is magnetically attracted to the left-side surface 117E of block 100E and the blocks 100A and 100E are magnetically interlocked.

The capacity for one block 100 to mate or interlock with another block 100 is initially determined by the potential magnetic force F between the magnets 120. The potential magnetic force Fₘ is effected by a predetermined distance between the magnets 120, the material in which the magnets 120 are embedded, that is, the material from which the blocks 100 are fabricated, and the particular magnet substrate (e.g., neodymium iron boron (NdFeB), samarium cobalt (SmCo), alnico, and ceramic or ferrite magnets). The potential magnetic force Fₘ between the magnets 120 is determined by the formulation:

Fₘ=Fₒ e^{-rd}

where Fₒ is the initial force (i.e., no separation distance between magnets), and e^{-rd} is the exponential function of the rate of magnetic field decay “r” of the magnet substrate and the distance “d” between the magnets.

In one embodiment of the present invention, the magnets 120 are embedded a predetermined distance X1 inwardly into block body 110 from a respective outer surface 112 in the range of from about 1 mm to about 5 mm. In one embodiment, the predetermined distance X1 is about 2 mm. In one embodiment, the initial force Fₒ of two magnets 120 is about 1.36 kg (3 lbs) at a distance d of 0. Thus, it can be estimated that at the predetermined distance X1 of about 2 mm, the potential magnetic force Fₘ between two the magnets 120 is about 0.32 kg (0.7 lbs).

In differing embodiments, two to five magnets 120 are embedded along one outer surface 112 of the block body 110. For example, the top surface 117A of block body 110A and the bottom surface 115B of the block body 110B are mated or interlocked by four pairs of magnets 120. Thus, the corresponding potential magnetic force Fₘ between the four pairs of magnets 120 is about 2.8 lbs (4 pairs×0.7 lbs per pair). Accordingly, the potential force of attraction of one outer surface 112 of one block 100 to another outer surface 112 of another block 100 is defined by the relation of the distance between a pair of interacting magnets 120 and the number of pairs of magnets interacting with each other. Thus, the total potential force of attraction Fₜ of one outer surface 112 of one block 100 to another outer surface 112 of another block 100 is determined by the formulation:

Fₜ=Σ Number of pairs of magnets×Fₒ e^{-rd}

The total potential force of attraction Fₜ is further effected by the density p of the material in which the magnets 120 are embedded, the material from which the blocks 100 are fabricated. For polymers and other amorphous materials, the higher the density of the material, the greater the resistance to the magnetic force carried therethrough. Accordingly, the total actual force of attraction Fₐ of one outer surface 112 of one block 100 to another outer surface 112 of another block 100 is diminished in an inverse relationship to the density ρ of the material from which the blocks 100 are fabricated. Thus, the total actual force of attraction Fₐ of one outer surface 112 of one block 100 to another outer surface 112 of another block 100 is determined by the formulation:

Fₐ=Σ Number of pairs of magnets×Fₒ e^{-rd} ×(1/p)

where ρ is the density of the material from which the blocks 100 are fabricated. Such density may be calculated as the mass of the block 100 divided by the volume of the block 100.

In one embodiment, to the density p of the material from which the blocks 100 are fabricated is in the range of about 1×10⁻⁶ kg/mm³ to about 1.25×10⁻⁶ kg/mm³.

In one embodiment, the predetermined distance X1 is about 2 mm and the density ρ of the material from which the blocks 100 are fabricated is about 1.2×10⁻⁶ kg/mm³.

The methods of manufacture of the present invention include a whole injection molded process and a whole additive manufacturing process wherein each process traps and encases the embedded magnets in a predetermined position within the molten plastic inside a sealed surface. Both processes enable the formation of a variety of three-dimensional geometric shapes of building blocks having magnets embedded therein, such as for example, cube, cuboid, spherical, cylinder, torus, triangular pyramid, square pyramid, truncated pyramid, triangular prism, and the like, and other more complex geometric shapes such as a dodecahedron.

The whole injection molded process of the present invention includes fabricating an injection mold which defines the shape of the building block 100. A fixture for suspending the magnets 120 within the mold in a predetermined configuration is fabricated and fixedly positioned within the mold, or integrally formed within the mold. Molten plastic is injected into the mold under sufficient pressure and subsequently cooled wherein the finished building block 100 is obtained. Lastly, the polarity of the outer surfaces 112 of respective blocks 100 are verified.

The whole additive manufacturing process of the present invention includes preparing a computer-aided design model for use as the blueprint for the additive manufacturing machine which defines the shape of the building block 100. The magnets 120 are positioned within the block body 110 during the additive manufacturing process, either manually or through automation (i.e., robots). A fixture may be employed for postioning the magnets 120 during the additive manufacturing process of the block body 110. The position of the magnets 120 during the additive manufacturing process is fixed or secured within the block body 110 by the molten plastic itself or by employing an adhesive such as glue. Lastly, the polarity of the outer surfaces 112 of respective blocks 100 are verified.

In one embodiment, the building block 100 is manufactured from a polymer using the whole injection molded process or the additive manufacturing process. Subsequently, one or more cavities of a predetermined configuration are hollowed out into which one or more magnets are disposed. The cavity is then resealed and polished. In one embodiment, the building block 100 is formed as a hollow block into which one or more magnets are disposed and sealed therein. In one embodiment, the magnets 120 are coated with a thermoset polymer, then heated and formed to a desired shape. In one embodiment, the building block 100 is manufactured via dual additive manufactured molding with automated insertion of the magnets 120.

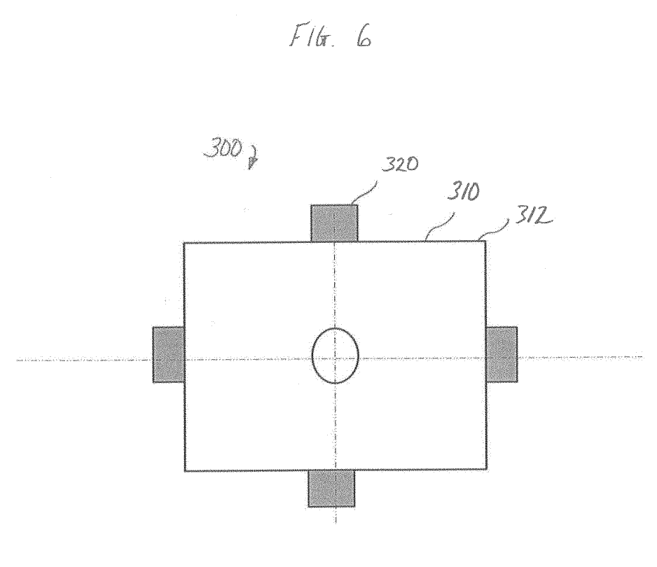

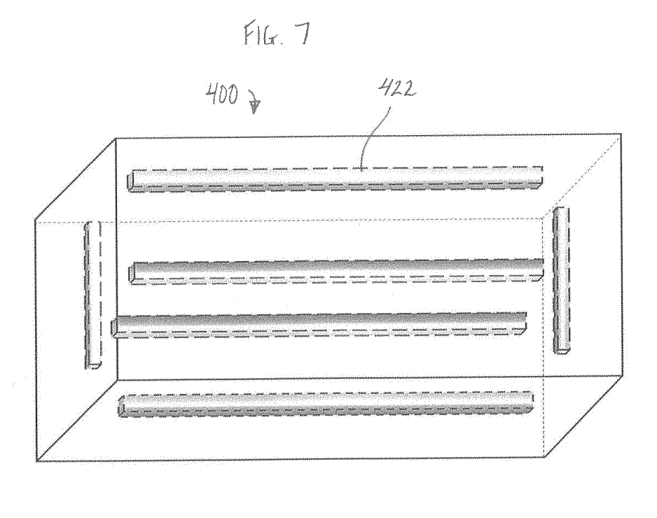

As shown in FIG. 5, in one embodiment, a block 200 includes a block body 210 having a plurality of magnets 220 embedded therein and positioned flush with an outer surface 212 thereof. The magnetic whole polymeric building Block Mold could be manufactured to have magnets sit on the surface of the blocks. As shown in FIG. 6, in one embodiment, a block 300 includes a block body 310 having a plurality of magnets 320 embedded therein and positioned extending outwardly from an outer surface 312 thereof.

As shown in FIG. 7, in one embodiment, a block 400 includes a block body 410 having one or metal components 422 embedded therein. Accordingly, blocks 100 having magnets 120 embedded therein are attracted to and will mate with blocks 400 because the metal components 422 are fabricated from, for example, iron (Fe) cobalt (Co), nickel (Ni), and to their respective based alloys.

In a finished condition, multiple building blocks 100 can be positioned to form selectively desired objects, such as for example, toy houses, toy cars, toy dinosaurs, toy trucks, toy dogs, and the like, based upon actual or imagined objects. The magnetic attraction of the respective outer surfaces 112 of the building blocks 100 would mate and interlock the different blocks 100 into a select position or configuration to form the desired object.

The building blocks 100 having the magnets 120 embedded therein can be used for other than play or entertainment purposes. Given the iron base of nails, a block 100 can be used to find studs in a wall by identifying the location of nails via magnetism. Because of the magnetic properties of the block 100, it can be used to fix items to appliances, such as a child's art to a refrigerator. Moreover, the blocks 100 can be employed to teach the principles of magnetics and magnetism to children. The blocks 100 can be used by an architect to build a model of a commercial or residential structure prior to building it wherein the model would serve as an opportunity to study a building design in a real-world application.

The blocks 100 of the present invention provide entertainment that enhances motor skills, creativity, critical thinking, spatial awareness and synergism. The blocks 100 further provide for ease of play for some persons who may have difficulty using building blocks with mechanical locking features. The blocks 100 also provide an opportunity to teach users about magnetism and magnetic properties of materials as well as bringing ideas from a two-dimensional configuration to a three-dimensional configuration.

The terms “first,” “second,” and the like, herein do not denote any order, quantity, or importance, but rather are used to distinguish one element from another. In addition, the terms “a” and “an” herein do not denote a limitation of quantity, but rather denote the presence of at least one of the referenced item.

Although the invention has been described with reference to particular embodiments thereof, it will be understood by one of ordinary skill in the art, upon a reading and understanding of the foregoing disclosure that numerous variations and alterations to the disclosed embodiments fall within the spirit and scope of this invention and of the appended claims. For example, those of ordinary skill in the art should recognize that one or more of the angles and dimensions of various structural features of the invention may be altered without deviating from the scope of the present invention.

What is claimed is:

1. An interlocking toy building block, the block comprising:
a first block body; and
at least one first magnet positioned inwardly into the first block body a first predetermined distance from a first outer surface of the first block body to provide a first predetermined magnetic polarity, positive or negative, to the first outer surface;
wherein, when the first outer surface is brought into close proximity with a second outer surface of a second block body having at least one second magnet positioned a second predetermined distance therein and exhibiting a second predetermined magnetic polarity opposing the first predetermined magnetic polarity, the first outer surface configured to mate with the second outer surface in an interlocking position.

2. The interlocking toy building block of claim 1, wherein the first and second predetermined distances are in the range of from about 1 mm to about 5 mm.

3. The interlocking toy building block of claim 1, wherein the first and second predetermined distances predetermined distances are equal.

4. The interlocking toy building block of claim 3, wherein the predetermined distance is in the range of about 2 mm.

5. The interlocking toy building block of claim 1, further comprising:
at least a first pair of magnets defined by the at least one first magnet and the at least one second magnet;
a potential magnetic force Fₘ between the at least one first magnet and the at least one second magnet determined by the formulation:
Fₘ=Fₒ e^{-rd}
where Fₒ is the initial force (i.e., no separation distance between magnets), and e^{-rd} is the exponential function of the rate of magnetic field decay “r” of a substrate of the magnets and the distance “d” between the magnets.

6. The interlocking toy building block of claim 1, wherein the first block body is fabricated from a material having a density in the range of about 1×10⁻⁶ kg/mm³ to about 1.25×10⁻⁶ kg/mm³.

7. The interlocking toy building block of claim 4, wherein the first block body is fabricated from a material having a density in the range of about 1×10⁻⁶ kg/mm³ to about 1.25×10⁻⁶ kg/mm³.
